(19) United States
(12) Patent Application Publication
(10) Pub. No.: US 2008/0106681 A1
(43) Pub. Date: May 8, 2008

(54) TRANSFLECTIVE LIQUID CRYSTAL DISPLAY

(75) Inventors: Chun-Chi CHI, Longjing Hsiang (TW); Chin-Chang LIU, Fongyuan City (TW)

Correspondence Address: PATENTTM.US, P. O. BOX 82788, PORTLAND, OR, 97282-0788, US

(73) Assignee: WINTEK CORPORATION, TANZIH HSIANG (TW)

(21) Appl. No.: 11/936,079

(22) Filed: Nov. 6, 2007

(30) Foreign Application Priority Data
Nov. 7, 2006 (TW) 095141119

(51) Int. Cl. G02F 1/1335

(52) U.S. Cl. 349/114

(57) ABSTRACT

A transflective liquid crystal display has a first substrate, multiple pixel units, a second substrate, a color filter layer, a transparent electrode, a liquid crystal layer and multiple dielectric layers. The bottom surface of the second substrate is opposite to the top surface of the first substrate. The multiple pixel units are defined on the first substrate, and each pixel unit has a transmissive region and a reflective region. The color filter layer is formed under the second substrate. The transparent electrode is formed under and entirely covers the color filter layer and is separated from the pixel electrodes to form a cell gap. The liquid crystal layer is formed between the first and second substrates. The multiple dielectric layers are formed under the transparent electrode, correspond respectively to the reflective regions and are separated respectively from the reflective layers to form another cell gap.

### BACKGROUND OF THE INVENTION

1. Field of the Invention

The present invention relates to a liquid crystal display (LCD), and more particularly to a transflective LCD that easily combines the characteristics in transmissive and reflective modes.

2. Description of Related Art

The advancement of semiconductor technology has resulted in most related products using semiconductors. Liquid crystal displays (LCDs) are becoming more prevalent in electronic devices in recent years, such as LCD televisions, LCD monitors, portable gaming machines, cell phones, multimedia devices and the like.

LCDs are categorized as active LCDs, reflective LCDs and transflective LCDs. Each active LCD uses a backlight module to provide light emitting sources. Each reflective LCD uses a reflective layer. The reflective layer is mounted inside the reflective LCD and reflects light emitted from outside of the reflective LCD to provide a light emitting source. However, the reflective LCD display images clearly or unclearly according to ambient illumination around the reflective LCD.

Transflective LCDs were invented to overcome the described shortcomings of the reflective LCDs because the transflective LCDs can alternately use backlight modules and ambient illumination to be the light emitting source, which are respectively so-called transmissive and reflective modes of the transflective LCDs. However, different light emitting sources have different characteristics, and further, different characteristics result in different display effects. With reference to FIG. 5, the relationship between the voltage and illumination of the reflective mode is different from the relationship between the voltage and illumination of transmissive mode.

A conventional solution uses two active elements such as thin-film transistors (TFTs) in each pixel unit. One active element controls the driving voltage in the reflective mode, and the other active element controls the driving voltage in the transmissive mode. The two active elements cause the <characteristics to be similar. However, using two active elements in each pixel unit either increases the production cost or reduces the manufacturing yield.

With reference to FIG. 6, another conventional solution uses a transflective LCD comprising a first substrate (71), multiple TFTs (711), a protective layer (78), a pixel electrode layer (79), multiple reflective layers (76), a second substrate (72), a filter layer (721), a transparent electrode layer (722) and a liquid crystal layer (73). The first substrate (71) comprises multiple pixel units. Each pixel unit has a transmissive region (74) and a reflective region (75). The TFTs (711) are formed respectively in the reflective regions (75) in the pixel units. The protective layer (78) is formed on the first substrate (71) and entirely covers the TFTs (711). The pixel electrode layer (79) is formed on the protective layer (78). The reflective layers (76) are formed on the pixel electrode layer (79) respectively in the reflective regions in the pixel units. The filter layer (721) is formed under the second substrate (72). The transparent electrode layer (722) is formed under the filter layer (721) and is separated from the reflective layer (76) in the reflective region and the pixel electrode layer (79) in the transmissive region in each pixel unit respectively by two different cell gaps (D1, D2), The liquid crystal layer (73) is between the transparent electrode layer (722) and the reflective layer (75) and the pixel electrode layer (79).

With further reference to FIG. 7, another way to form the two different cell gaps (D1, D2) is to form a spacer (77) between the protective layer (78) and the pixel electrode layer (79) in the reflective region (74) in each pixel unit. Therefore, the cell gap (D1) in the reflective region (74) is smaller than the cell gap (D2) in the transmissive region (75) to adjust the characteristics of the transflective LCDs. However, determining the optimal cell gaps (D1, D2) is to difficult.

To overcome the shortcomings, the present invention provides a transflective LCD to mitigate or obviate the aforementioned problems.

### SUMMARY OF THE INVENTION

The main objective of the invention is to provide a transflective liquid crystal display (LCD) the characteristics in the transmissive mode and the reflective mode are easily optimized.

A transflective LCD in accordance with the present invention comprises a first substrate, multiple pixel units, a second substrate, a color filter layer, a transparent electrode, a liquid crystal layer and multiple dielectric layers. The bottom surface of the second substrate is opposite to the top surface of the first substrate. The multiple pixel units are defined on the first substrate, and each pixel unit has a transmissive region and a reflective region. The color filter layer is formed under the second substrate. The transparent electrode is formed under and entirely covers the color filter layer and is separated from the pixel electrodes in the first substrate to form a cell gap. The liquid crystal layer is formed between the first substrate and the second substrate. The multiple dielectric layers are formed under the transparent electrode, correspond respectively to the reflective regions in the first substrate and are separated respectively from the reflective layers in the first substrate to form another cell gap.

Other objectives, advantages and novel features of the invention will become more apparent from the following detailed description when taken in conjunction with the accompanying drawings.

### BRIEF DESCRIPTION OF THE DRAWING

FIG. 1 is a cross-section in partial section of a first embodiment of a pixel unit in a transflective liquid crystal display (LCD) in accordance with the present invention;

FIG. 2 is a circuit diagram of the transflective LCD in FIG. 1;

FIG. 3 is a cross-section in partial section of a second embodiment of a pixel unit in a transflective LCD in accordance with the present invention;

FIG. 4 is a cross-section in partial section of a third embodiment of a pixel unit in a transflective LCD in accordance with the present invention;

FIG. 5 is a graph of illumination based on applied voltage of a conventional transflective LCD in reflective and transmissive modes;

FIG. 6 is a cross-section in partial section of a pixel unit in a conventional transflective LCD; and

FIG. 7 is a cross-section in partial section of a conventional transflective LCD having a spacer in each pixel unit.

### DETAILED DESCRIPTION OF PREFERRED EMBODIMENT

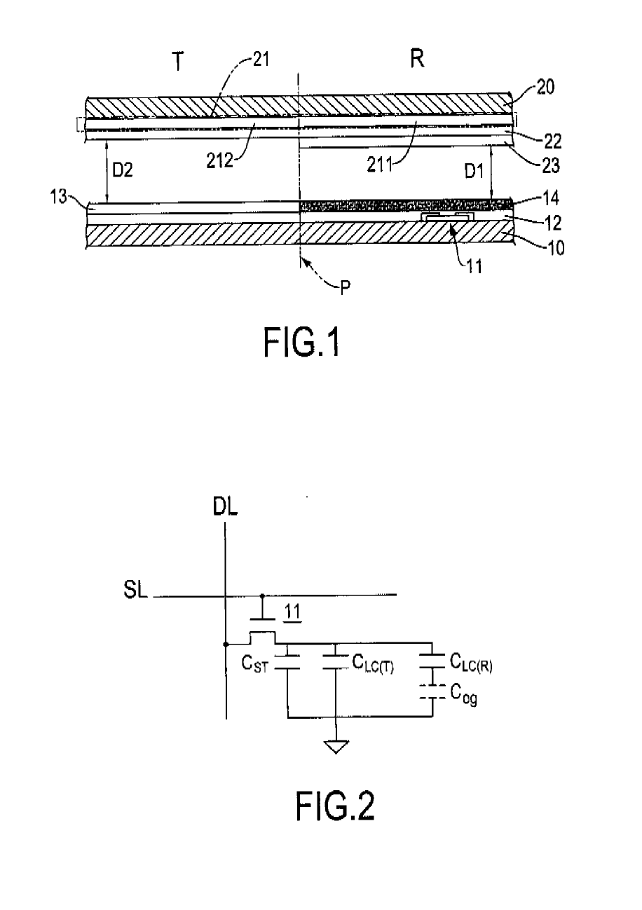

With reference to FIG. 1, a transflective liquid crystal display (LCD) in accordance with the present invention may be designed in any optics mode, such as vertical alignment mode, mixed-twisted nematic mode, twisted nematic mode or the like and comprises a first substrate (10), multiple pixel units (P), multiple thin-film transistors (TFT) (11), multiple capacitors, an protective layer (12), multiple pixel electrodes (13), multiple reflective layers (14), a second substrate (20), a color filter layer (21), a transparent electrode (22), a liquid crystal layer and multiple dielectric layers (23).

The first substrate (10) has a top surface and may have multiple scanning lines and multiple data lines. The scanning lines and the data lines are formed on the top surface of the first substrate (10) and crisscross each other.

The pixel units (P) are defined on the top surface of the first substrate (10), and each pixel unit comprises a transmissive region (T) and a reflective region (R) and may be defined between adjacent scanning lines and data lines, whereby the pixel units (P) are formed in a matrix configuration.

The TFTs (11) are mounted on the top surface of the first substrate (10) respectively in the pixel units (P). With further reference to FIG. 2, each TFT (11) has a gate terminal, a source terminal and a drain terminal. The gate terminal is connected to the adjacent scanning line (SL). The source terminal is connected to the adjacent data line (DL).

The capacitors (C_{ST}) are mounted on the top surface of the first substrate (10) respectively in the pixel units (P), and each capacitor (C_{ST}) is connected to the drain terminal of the TFT (11) in the pixel unit (P).

The protective layer (12) is formed on the top surface of the first substrate (10) and entirely covers the scanning and data lines (SL, DL), the TFTs (11) and the capacitors (C_{ST}).

The pixel electrodes (13) are formed on the protective layer (12) respectively in the transmissive regions (T) of the pixel units (P). Furthermore, the pixel electrodes (13) are made of transparent conductivity materials, such as indium tin oxide (ITO).

The reflective layers (14) are formed on the protective layer (12) respectively in the reflective regions (R) of the pixel units (P), are coupled respectively to the pixel electrodes (13) of the pixel units (P). Furthermore, the reflective layers (14) are made of high reflectance metals.

The second substrate (20) has a bottom surface. The bottom surface of the second substrate (20) is opposite to the top surface of the first substrate (10).

The color filter layer (21) is formed on the bottom surface of the second substrate (20) and comprises multiple first color filters (211) and multiple second color filters (212).

The first color filters (211) correspond respectively to the reflective regions (R) in the first substrate (10).

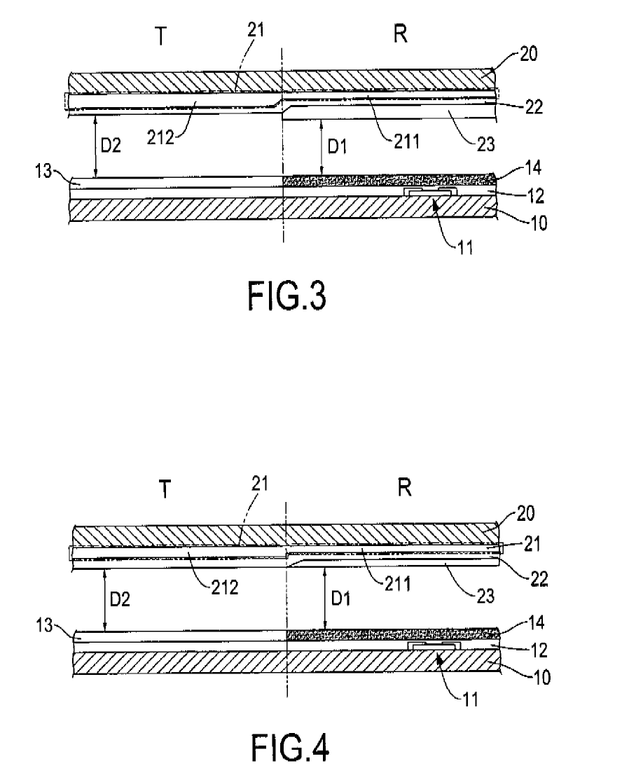

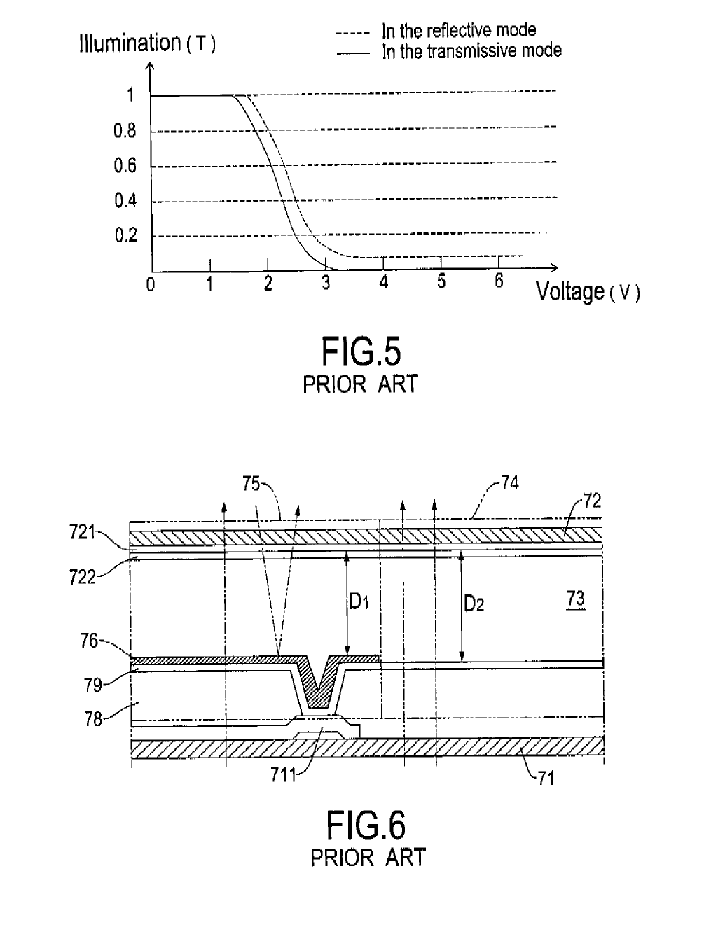

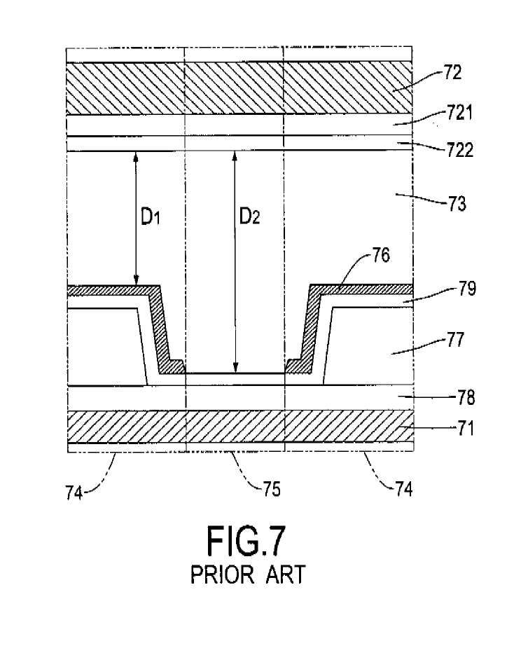

The second color filters (212) correspond respectively to the transmissive regions (T) in the first substrate (10). With further reference to FIGS. 3 and 4, the thickness of each second color filter (212) is equal to or larger than the thickness of the first color filter (211) in the same pixel unit (P).

The transparent electrode (22) is formed under and entirely covers the color filter layer (21) and is separated from the pixel electrodes (13) in the first substrate (10) to form a cell gap (D2).

The liquid crystal layer is formed between the first substrate (10) and the second substrate (20) and comprises multiple first and second liquid crystal capacitors (C_{LC(R)}, C_{LC(T)}). The first liquid crystal capacitors (C_{LC(R)}) correspond respectively to the reflective regions (R) in the pixel units (P), and each first liquid crystal capacitor (C_{LC(R)}) and the capacitor (C_{ST}) are electronically connected in parallel to the drain terminal of the TFT (11) in the corresponding pixel unit (P). The second liquid crystal capacitors (C_{LC(T)}) correspond respectively to the transmissive regions (T) in the pixel units (P), and each second liquid crystal capacitor (C_{LC(T)}), the capacitor (C_{ST}) and the first liquid crystal capacitor (C_{LC(R)}) are electronically connected in parallel to the drain terminal of the TFT (11) in the corresponding pixel unit (P).

The dielectric layers (23) are formed under the transparent electrode (22), correspond respectively to the reflective regions (R) in the first substrate (10) and are separated respectively from the reflective layers (14) in the first substrate (10) to form a cell gap (D1). Furthermore, the dielectric layers (23) are made of SiNx or organic dielectric material.

The thickness of each dielectric layer (23) and the thickness of each first color filter (211) change the corresponding cell gap (D1) between the reflective layer (14) and the dielectric layer (23) in each pixel unit (P). Therefore, the cell gap (D1) between the reflective layer (14) and the dielectric layer (23) in each pixel unit (P) may be smaller than or equal to the cell gap (D2) between the pixel electrode (13) and the transparent electrode (22) in each pixel unit (P).

Furthermore, the dielectric layers (23) form an additional compensation capacitor (C_{og}) to influence electric fields respectively between the reflective layers (14) and the transparent electrode (22) in each pixel unit (P). The compensation capacitors (C_{og}) are electronically connected in series and respectively to the first liquid crystal capacitors (C_{LC(R)}) in the pixel units (P). Accordingly, the total capacitance of the first liquid crystal capacitor (C_{LC(R)}) and the compensation capacitors (C_{og}) is lower than the capacitance of the first liquid crystal capacitor (C_{LC(R)}), and the capacitance of the second liquid crystal capacitor (C_{LC(T)}) is constant. Therefore, the relationship between the voltage and reflectance when the transflective LCD is operating in reflective mode is adjusted to be closer to the relationship between the voltage and transmittance when the transflective LCD is operating in transmissive mode.

The transflective LCD described has the following advantages.

1. The transflective LCD that requires forming a dielectric layer (23) in each pixel unit (P) is easier to fabricate than the conventional transflective LCD that requires installing two active elements. Therefore, either the production costs for manufacturing the transflective LCD reduces or the manufacturing yield of manufacturing the transflective LCD increases.

2. The dielectric layers (23) either form the additional compensation capacitor (C_{og}) to influence an electric fields between the reflective layers (14) and the transparent electrode (22) in each pixel unit (P) to adjust the characteristics of the transflective LCD, or the thickness of each dielectric layer (23) reduce the cell gap (D1) between the reflective layer (14) on the first substrate (10) and the dielectric layer (23) in each pixel unit (P) to adjust the characteristics of the transflective LCD.

3. The transflective LCD has better level in National Television Standards Committee (NTSC) standard because the color filter layer (21) is manufactured by the thin-film method with different thickness.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A transflective liquid crystal display comprising:
a first substrate having a top surface;
multiple pixel units defined on the top surface of the first substrate, and each pixel unit comprising a transmissive region and a reflective region;
a second substrate having a bottom surface being opposite to the top surface of the first substrate;
a color filter layer being formed on the bottom surface of the second substrate;
a transparent electrode being formed under and entirely covering the color filter layer and separated from the first substrate to form a cell gap;
a liquid crystal layer being formed between the first substrate and the second substrate; and
multiple dielectric layers being formed under the transparent electrode, corresponding respectively to the reflective regions in the first substrate and being separated respectively from the first substrate to form another cell gap.

2. The transflective liquid crystal display as claimed in claim 1, wherein the color filter layer further comprises
multiple first color filters corresponding respectively to the reflective regions in the first substrate; and
multiple second color filters corresponding respectively to the transmissive regions in the first substrate, and the thickness of the second color filter being larger than the thickness of the first color filter in the same pixel unit.

3. The transflective liquid crystal display as claimed in claim 1, wherein the two cell gaps are equal to each other.

4. The transflective liquid crystal display as claimed in claim 1, wherein the cell gap in the reflective region is smaller than the cell gap in the transmissive region.

5. The transflective liquid crystal display as claimed in claim 1, wherein the dielectric layers are SiNx.

6. The transflective liquid crystal display as claimed in claim 1, wherein the dielectric layers are organic dielectric material.

7. The transflective liquid crystal display as claimed in claim 2, wherein the two cell gaps are equal to each other.

8. The transflective liquid crystal display as claimed in claim 2, wherein the cell gap in the reflective region is smaller than the cell gap in the transmissive region.

9. The transflective liquid crystal display as claimed in claim 2, wherein the dielectric layers are made of SiNx.

10. The transflective liquid crystal display as claimed in claim 2, wherein the dielectric layers are made of organic dielectric material.

11. The transflective liquid crystal display as claimed in claim 3, wherein the dielectric layers are made of SiNx.

12. The transflective liquid crystal display as claimed in claim 3, wherein the dielectric layers are made of organic dielectric material.

13. The transflective liquid crystal display as claimed in claim 4, wherein the dielectric layers are made of SiNx.

14. The transflective liquid crystal display as claimed in claim 4, wherein the dielectric layers are made of organic dielectric material.
